(19) United States
(12) Patent Application Publication
(10) Pub. No.: US 2011/0299086 A1
(43) Pub. Date: Dec. 8, 2011

(54) SENSING DEVICE AND IMAGE SENSING SYSTEM THEREOF

(75) Inventors: Hui Hsuan Chen, Hsinchu City (TW); Cheng Nan Tsai, Hsinchu City (TW); Chih Hung Lu, Hsinchu City (TW); Wei Chung Wang, Hsinchu City (TW)

(73) Assignee: PIXART IMAGING INC., Hsinchu City (TW)

(21) Appl. No.: 12/880,457

(22) Filed: Sep. 13, 2010

(30) Foreign Application Priority Data
Jun. 2, 2010 (TW) 099210497

(51) Int. Cl. G01N 21/55

(52) U.S. Cl. 356/445

(57) ABSTRACT

A sensing device includes a housing and an image sensing system disposed in the housing and used for detecting a reflected light from an object. The image sensing system includes a substrate, a light sensing element, and a reflection and redirection element. The light sensing element is disposed on the substrate. The reflection and redirection element is disposed between the light sensing element and the object, and used for reflecting and redirecting the reflected light from the object to a receiving direction of the light sensing element, such that the light sensing element receives the reflected light and generates a corresponding sensing signal.

### CROSS-REFERENCE TO RELATED APPLICATIONS

This non-provisional application claims priority under 35 U.S.C. §119(a) on Patent Application No(s). 099210497 filed in Taiwan, R.O.C. on Jun. 2, 2010, the entire contents of which are hereby incorporated by reference.

### BACKGROUND OF THE INVENTION

1. Field of the Invention

The present invention relates to a sensing device, and more particularly to a sensing device having an image sensing system.

2. Related Art

In recent years, multi-media entertainment market is rapidly developed, and many game hosts attract a player to a background scene of a game by providing a colorful acousto-optic effect, and thus allow the player to be immersed in a cartoon or movie, so as to fully experience the entertainment. Software and hardware manufacturers continuously propose newer and better game software and game hosts, so as to occupy gigantic market business opportunity. As the newer and more special software and hardware are proposed, the game joystick, as the main game manipulation interface, definitely must be continuously developed and modified, so as to meet the demand of the pleasant sensation of the user during manipulation.

For example, a peripheral device dedicated to game manipulation, such as a game joystick or a game controller, allows for vivid and smooth manipulation by an operator during the game. Recently, a game controller capable of achieving wireless manipulation by means of optical sensing is further developed, such that the user can generate a corresponding control signal through a relative displacement of the game controller, and thus control cursor or interface manipulation settings in a game scene.

A conventional wireless game controller has an optical sensor module disposed therein for detecting an image formed by a light incident from the outside of the game controller, so as to generate a corresponding control signal. In order to successfully receive the light incident from the outside, the optical sensor module of the conventional wireless game controller is laterally placed on a circuit board, such that a light receiving direction of the optical sensor module directly faces an incident direction of the light, that is, the receiving direction of the optical sensor module is corresponding to an opening of a housing of the game controller.

Moreover, in order to achieve the configuration of the optical sensor module laterally placed on the circuit board at an angle of 90 degrees, the optical sensor module must be disposed in an electrical socket, such that the receiving direction of the optical sensor module is parallel to the reflection direction of the light by means of the lateral arrangement of the electrical socket; alternatively, the optical sensor module is laterally electrically disposed on the circuit board at an angle of 90 degrees by means of a design of a gold finger, such that the receiving direction of the optical sensor module is parallel to the reflection direction of the light.

Since the optical sensor module of the conventional wireless game controller needs to use the structural design of the electrical socket or the gold finger in order to successfully receive the reflected light from the outside, the optical sensor module has a complex structure and requires more production procedures, resulting in that the production efficiency cannot be improved, and the production cost cannot be lowered.

### SUMMARY OF THE INVENTION

In view of the above technical problems, the present invention is a sensing device and an image sensing system thereof, which can overcome the problems of excessively complex structure and production procedures of the conventional optical sensor module caused by the lateral arrangement of the optical sensor module on the circuit board in the conventional wireless control device.

The image sensing system of the present invention is applicable in a sensing device, and used for detecting a reflected light from an object. The image sensing system comprises a substrate, a light sensing element, and a reflection and redirection element. The light sensing element is disposed on the substrate, and has a receiving direction. The reflection and redirection element is disposed between the object and the light sensing element, and corresponding to the receiving direction of the light sensing element. The reflection and redirection element reflects the reflected light from the object, and redirects the reflected light to the receiving direction of the light sensing element, such that the light sensing element receives the reflected light and generates a corresponding sensing signal.

The sensing device of the present invention comprises a housing and an image sensing system. The housing has an accommodation space therein, and has a through hole. The image sensing system is disposed in the housing, and used for detecting a reflected light from an object, and comprises a substrate, a light sensing element, and a reflection and redirection element. The light sensing element is disposed on the substrate, and has a receiving direction. The reflection and redirection element is disposed between the object and the light sensing element, and corresponding to the receiving direction of the light sensing element. The reflected light from the object passes through the through hole and enters the housing, and the reflection and redirection element reflects the reflected light from the object, and redirects the reflected light to the receiving direction of the light sensing element, such that the light sensing element receives the reflected light and generates a corresponding sensing signal.

The effect of the present invention lies in that, the refraction path of the reflected light from the object is changed by the reflection and redirection element to be consistent with the receiving direction of the light sensing element, so that the light sensing element can be directly disposed on the substrate without being laterally disposed on the substrate at an angle of 90 degrees by means of a socket or a gold finger, which significantly simplifies the production process, thereby reducing the production cost and facilitating the assembly.

### BRIEF DESCRIPTION OF THE DRAWINGS

The present invention will become more fully understood from the detailed description given herein below for illustration only, and thus are not limitative of the present invention, and wherein:

FIG. 1 is a schematic view of an image sensing system according to the present invention;

FIG. 2 is a cross-sectional view of a sensing device according to a first embodiment of the present invention;

FIG. 3 is a cross-sectional view of a sensing device according to a second embodiment of the present invention;

FIG. 4 is a cross-sectional view of a sensing device according to a third embodiment of the present invention;

FIG. 5A is a cross-sectional view of a sensing device having a reflection and redirection element at a different position according to the present invention;

FIG. 5B is a cross-sectional view of a sensing device having a reflection and redirection element at a different position according to the present invention;

FIG. 5C is a cross-sectional view of a sensing device having a reflection and redirection element at a different position according to the present invention;

FIG. 6A is a cross-sectional view of a sensing device according to a fourth embodiment of the present invention;

FIG. 6B is a cross-sectional view of a sensing device of a different form according to the fourth embodiment of the present invention; and

FIG. 6C is a cross-sectional view of a sensing device of a different form according to the fourth embodiment of the present invention.

### DETAILED DESCRIPTION OF THE INVENTION

The image sensing system of the present invention is applicable in sensing devices comprising, but not limited to, peripheral devices such as a cell phone, a joystick control device, and a game pad. In the detailed description of the present invention below, the game pad is used as the most preferred embodiment of the present invention. However, the accompanying drawings are provided for reference and description only, but not intended to limit the present invention.

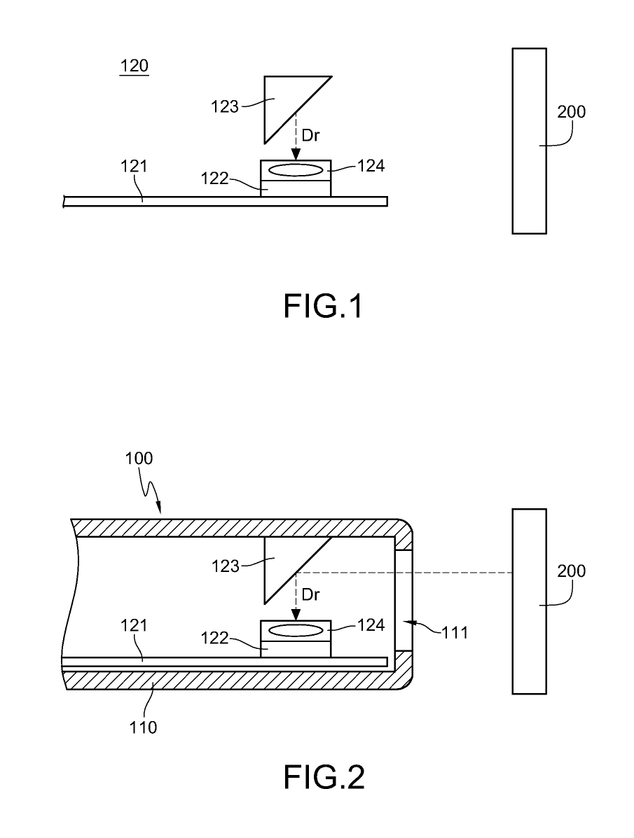

FIG. 1 is a schematic view of an image sensing system according to the present invention. Referring to FIG. 1, an image sensing system 120 of the present invention is used for detecting a reflected light from an object 200, and comprises a substrate 121, a light sensing element 122, and a reflection and redirection element 123. The light sensing element 122 is disposed on a surface of the substrate 121, and a receiving direction Dr of the light sensing element 122 for receiving the reflected light is substantially parallel to the object 200. The reflection and redirection element 123 is disposed between the light sensing element 122 and the object 200, and corresponding to the receiving direction Dr of the light sensing element 122, for example, the reflection and redirection element 123 is located in the receiving direction Dr, but the present invention is not limited thereto. The reflection and redirection element 123 functions to redirect and reflect the reflected light from the object 200 to the receiving direction Dr of the light sensing element 122, such that the light sensing element 122 receives and senses the reflected light, and generates a corresponding sensing signal.

The substrate 121 of the present invention may be a circuit board, and thus the light sensing element 122 is electrically disposed on the substrate 121; however, persons skilled in the art may also electrically connect the light sensing element 122 to an external component in an external manner, and the present invention is not limited thereto. Moreover, the detection and computation means of the image sensing system 120 comprises, but is not limited to, an image detection mode or an optical refraction change detection mode, and since this part is not a subject matter of the present invention, the details will not be described herein. The light sensing element 122 of the present invention may be, but is not limited to, a charged coupled device (CCD) or a complementary metal-oxide semiconductor (CMOS).

FIG. 2 is a cross-sectional view of a sensing device according to a first embodiment of the present invention. Referring to FIG. 2, a sensing device 100 according to the first embodiment comprises a housing 110 and the image sensing system 120. The housing 110 is substantially a rectangular structure, but the present invention is not limited thereto. The housing 110 has an accommodation space therein for accommodating the image sensing system 120, and has a through hole 111 opened on a side surface thereof.

Still referring to FIG. 2, the image sensing system 120 according to the first embodiment of the present invention is used for detecting a reflected light from an object 200, and comprises a substrate 121, a light sensing element 122, and a reflection and redirection element 123. The light sensing element 122 is electrically disposed on a surface of the substrate 121, and a receiving direction Dr of the light sensing element 122 for receiving the reflected light is substantially parallel to the object 200. The reflection and redirection element 123 is disposed between the light sensing element 122 and the object 200, and corresponding to the receiving direction Dr of the light sensing element 122, for example, the reflection and redirection element 123 is located in the receiving direction Dr, but the present invention is not limited thereto.

In particular, the light sensing element 122 is perpendicularly disposed on the substrate 121, and thus the receiving direction Dr of the light sensing element 122 is also perpendicular to the substrate 121. Moreover, since the receiving direction Dr is parallel to the object 200, the object 200 is also perpendicular to the substrate 121.

The image sensing system 120 according to this embodiment further comprises a first lens 124 disposed on the light sensing element 122, and corresponding to the receiving direction Dr of the sensing module 122. The first lens 124 may be, but is not limited to, a plate-like light transmissive plate, a plano-concave lens, a double concave lens, a plano-convex lens, and a double convex lens.

As shown in FIG. 2, the reflected light from the object 200 passes through the through hole 111 of the housing 110 to the reflection and redirection element 123, and the reflection and redirection element 123 redirects and reflects the reflected light from the object 200 to the receiving direction Dr of the light sensing element 122, the first lens 124 images the reflected light, and the light sensing element 122 receives and senses the reflected light, and generates a corresponding sensing signal. The light sensing element 122 of the present invention may be, but is not limited to, a charged coupled device (CCD) or a complementary metal-oxide semiconductor (CMOS).

The reflection and redirection element 123 may be a reflective mirror or a reflective prism; however, persons skilled in the art may also adopt other light guide means, which are not limited to the embodiment disclosed in the present invention. Furthermore, an angle of the reflection and redirection element 123 may be adjusted according to practical application requirements, so as to correspondingly change the incident angle of the reflected light from the object 200. The reflection and redirection element 123 of the present invention may be optionally coated with a reflective film 1231 on a surface thereof, so as to increase the reflective index of the reflection and redirection element 123 (as shown in a cross-sectional view of a third embodiment in FIG. 4), and the reflective film 1231 may be made of, for example, but not limited to, a metal material such as aluminum (Al) or silver (Ag).

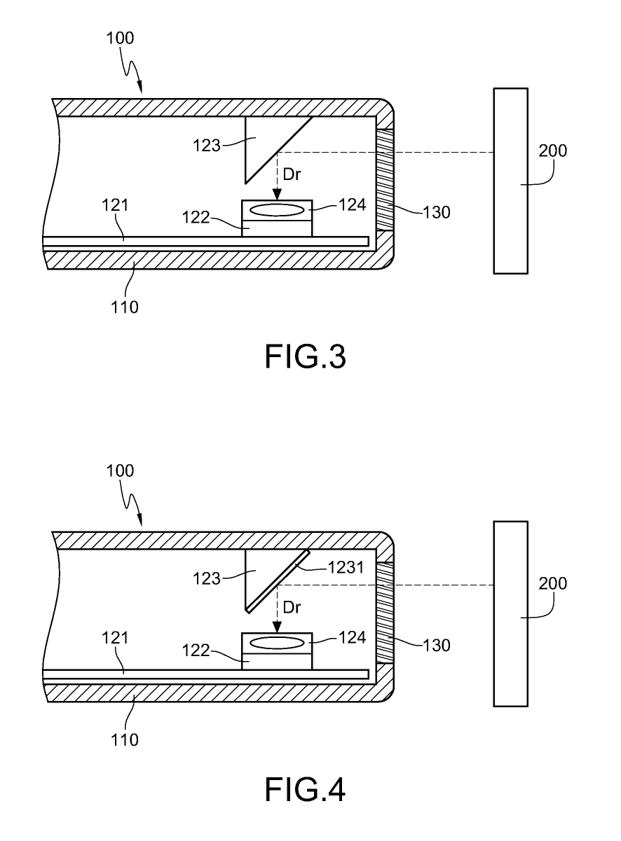

FIG. 3 is a cross-sectional view of a sensing device according to a second embodiment of the present invention. Referring to FIG. 3, a sensing device 100 according to the second embodiment of the present invention has a structure similar to that of the sensing device 100 according to the first embodiment of the present invention, except that the sensing device 100 according to the second embodiment further comprises a color filter 130, in addition to the housing 110, the substrate 121, the light sensing element 122, the reflection and redirection element 123, and the first lens 124. The color filter 130 is disposed in the through hole 111 of the housing 110, and thus is located in a transmission path of the reflected light from the object 200, such that the reflected light entering the housing 110 is limited to a light having a certain wavelength.

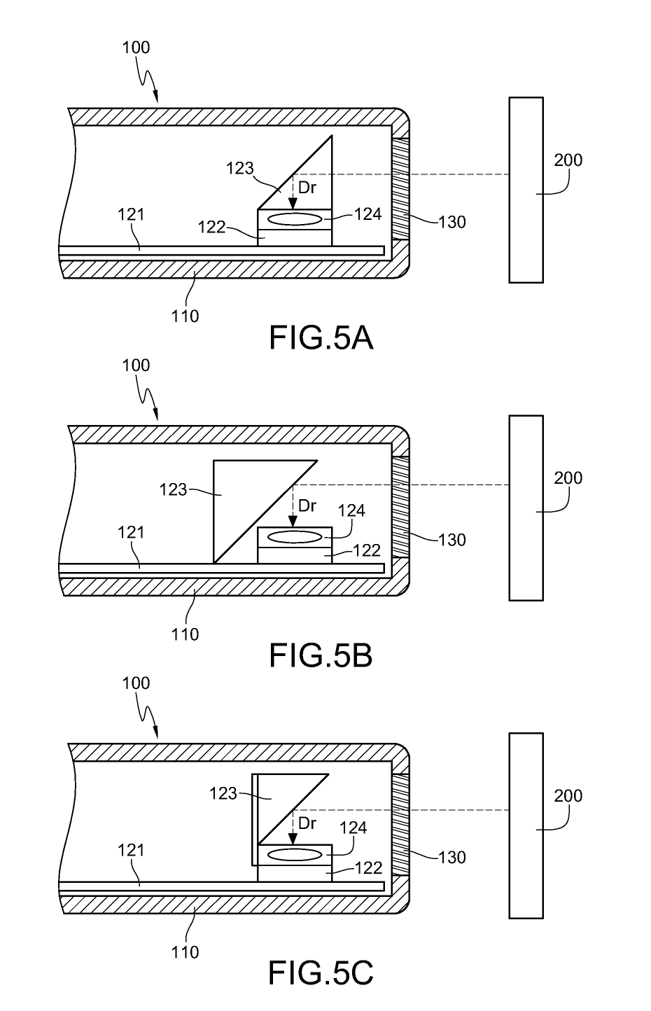

The reflection and redirection element 123 of the present invention may not only be disposed on a side surface of the housing 110 opposite to the light sensing element 122 (as shown in FIG. 2), but may also be directly disposed on the light sensing element 122, and corresponding to the receiving direction Dr of the light sensing element 122, as shown in a schematic view of FIG. 5A. Alternatively, the reflection and redirection element 123 may be disposed on the light sensing element 122 in a form of a suitable clamp, and corresponding to the receiving direction Dr of the light sensing element 122, as shown in a schematic view of FIG. 5B. Alternatively, the reflection and redirection element 123 may be disposed on the substrate 121, and corresponding to the receiving direction Dr of the light sensing element 122, as shown in a schematic view of FIG. 5C.

It should be noted that, the reflection and redirection element 123 and the housing 110 may be integrally formed, or the reflection and redirection element 123 is additionally disposed on the housing 110, the light sensing element 122, or the substrate 121 by a suitable bonding means, but the present invention is not limited thereto.

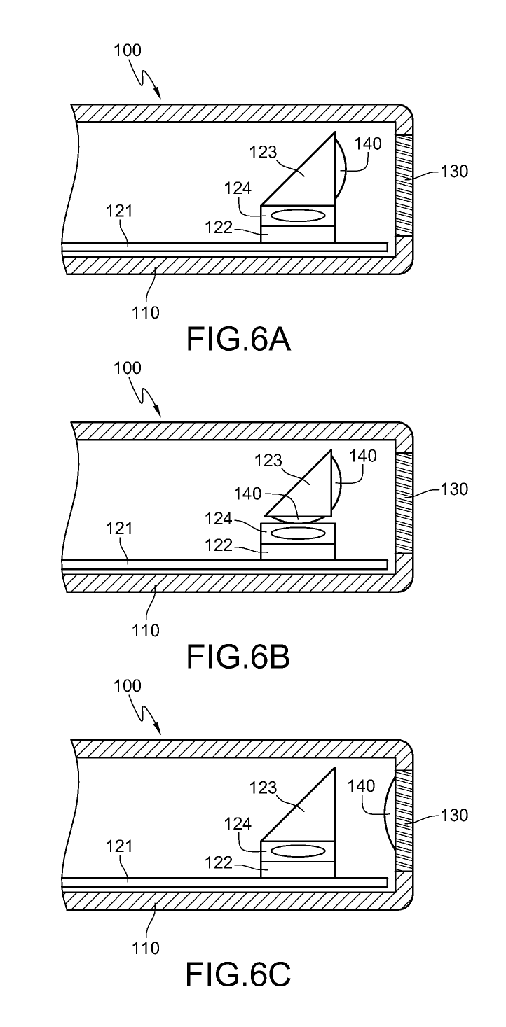

Referring to FIGS. 6A to 6C, a sensing device 100 according to a fourth embodiment of the present invention has a structure similar to those of the sensing devices 100 of the above embodiments, except that the sensing device 100 according to the fourth embodiment further comprises at least one second lens 140, in addition to the housing 110, the substrate 121, the light sensing element 122, the reflection and redirection element 123, and the first lens 124. The second lens 140 may be, but is not limited to, a plate-like light transmissive plate, a plano-concave lens, a double concave lens, a plano-convex lens, and a double convex lens.

For example, as shown in FIG. 6A, the second lens 140 may be disposed on a side surface of the reflection and redirection element 123 facing the color filter 130, and located in the transmission path of the reflected light from the object 200. Alternatively, as shown in FIG. 6B, the second lenses 140 may be respectively disposed on the side surface of the reflection and redirection element 123 facing the color filter 130, and a side surface of the reflection and redirection element 123 facing the light sensing element 122, and both located in the transmission path of the reflected light from the object 200. Alternatively, as shown in FIG. 6C, the second lens 140 may be disposed on a side surface of the color filter 130 facing the interior of the housing 110, and located in the transmission path of the reflected light from the object 200.

In the structures as shown in FIGS. 6A to 6C, by providing the second lens 140, the problem of reduction in image resolution caused by the refraction and redirection by the reflection and redirection element 123 can be solved, thereby greatly improving the imaging quality.

The image sensing system of the present invention is applicable in sensing devices for which a control interface is effected by means of image sensing, such as a cell phone, a joystick control device, and a game pad, and the sensing devices can achieve the objective of imaging sensing and control by simply disposing the image sensing system of the present invention in the sensing devices.

Taking a cell phone as an example, after the image sensing system of the present invention is disposed in the cell phone, the cell phone is enabled to sense external images, and execute a variety of preset programs and functions in a non-touch manner by means of image sensing. Taking a joystick control device as an example, after the image sensing system of the present invention is disposed in the joystick control device, the joystick control device is enabled to sense external images, and control a displacement motion of a cursor by means of image sensing.

The above is merely a simple description of the applications in the cell phone and the joystick control device, the application range of the sensing device and the image sensing system thereof according to the present invention is not limited thereto, and the image sensing system of the present invention can further be applied in various sensing devices requiring control means of image sensing.

In the sensing device of the present invention, the reflection and redirection element of the image sensing system redirects and reflects the reflected light from the object to the receiving direction of the light sensing element, such that the transmission path of the reflected light from the object is consistent with the receiving direction of the light sensing element. Therefore, the light sensing element can be directly perpendicularly disposed on the substrate without being laterally disposed on the substrate by means of a socket or a gold finger, which significantly simplifies the production procedures and structure, thereby reducing the production cost, and improving the assembly and production efficiency.

Moreover, a second lens may be further additionally disposed on the reflection and redirection element or the color filter, so as to solve the problem of poor image resolution, thereby greatly improving the imaging quality.

What is claimed is:

1. An image sensing system, applicable in a sensing device, for detecting a reflected light from an object, the image sensing system comprising:
a substrate;
a light sensing element, disposed on the substrate, and having a receiving direction; and
a reflection and redirection element, disposed between the light sensing element and the object, and corresponding to the receiving direction of the light sensing element;
wherein the reflection and redirection element reflects and redirects the reflected light to the receiving direction, and the light sensing element receives the reflected light and generates a corresponding sensing signal.

2. The image sensing system according to claim 1, further comprising a first lens, disposed on the light sensing element, and corresponding to the receiving direction of the light sensing element.

3. The image sensing system according to claim 1, further comprising a color filter, disposed between the object and the reflection and redirection element.

4. The image sensing system according to claim 3, further comprising a second lens, disposed on the color filter, and corresponding to a transmission path of the reflected light.

5. The image sensing system according to claim 1, further comprising at least one second lens, disposed on the reflection and redirection element, and corresponding to a transmission path of the reflected light.

6. The image sensing system according to claim 1, wherein the reflection and redirection element further has a reflective film on a surface thereof.

7. The image sensing system according to claim 1, wherein the reflection and redirection element is a reflective mirror.

8. The image sensing system according to claim 1, wherein the reflection and redirection element is a reflective prism.

9. A sensing device, comprising:
a housing, having an accommodation space therein, and having a through hole; and
an image sensing system, disposed in the housing, for detecting a reflected light from an object, the image sensing system comprising:
a substrate;
a light sensing element, disposed on the substrate, and having a receiving direction; and
a reflection and redirection element, disposed between the light sensing element and the object, and corresponding to the receiving direction of the light sensing element;
wherein the reflected light from the object passes through the through hole and enters the housing, the reflection and redirection element reflects and redirects the reflected light to the receiving direction, and the light sensing element receives the reflected light and generates a corresponding sensing signal.

10. The sensing device according to claim 9, wherein the image sensing system further comprises a first lens, disposed on the light sensing element, and corresponding to the receiving direction of the light sensing element.

11. The sensing device according to claim 9, further comprising a color filter, disposed in the through hole, and located between the object and the reflection and redirection element.

12. The sensing device according to claim 11, further comprising a second lens, disposed on the color filter, and corresponding to a transmission path of the reflected light.

13. The sensing device according to claim 9, further comprising at least one second lens, disposed on the reflection and redirection element, and corresponding to a transmission path of the reflected light.

14. The sensing device according to claim 9, wherein the reflection and redirection element is disposed on the housing.

15. The sensing device according to claim 9, wherein the reflection and redirection element is disposed on the light sensing element.

16. The sensing device according to claim 9, wherein the reflection and redirection element is disposed on the substrate.

17. The sensing device according to claim 9, wherein the reflection and redirection element further has a reflective film on a surface thereof.

18. The sensing device according to claim 9, wherein the reflection and redirection element is a reflective mirror.

19. The sensing device according to claim 9, wherein the reflection and redirection element is a reflective prism.
